(19) United States
(12) Patent Application Publication
(10) Pub. No.: US 2018/0075157 A1
(43) Pub. Date: Mar. 15, 2018

(54) Method and System for Converting Disparate Financial, Regulatory, and Disclosure Documents to a Linked Table

(71) Applicant: Harsha NARAYAN, San Jose, CA (US)

(72) Inventor: Harsha NARAYAN, San Jose, CA (US)

(21) Appl. No.: 15/554,685

(22) PCT Filed: Mar. 10, 2016
(86) PCT No.: PCT/US16/21840

§ 371 Date: Aug. 30, 2017

Related U.S. Application Data
(60) Provisional application No. 62/131,176, filed on Mar. 10, 2015.

(51) Int. Cl. G06F 17/30; G06F 17/24

(52) U.S. Cl. CPC G06F 17/30896; G06F 17/30014; G06Q 10/10; G06F 17/30002; G06F 17/30076; G06F 17/245

(57) ABSTRACT

Disclosed are systems and methods for converting disparate documents to a linked table, for one or more financial entities. More particularly, at least one embodiment of the present invention pertains to a method and apparatus for converting disparate financial, regulatory, and disclosure documents to a linked table. For instance, the system and method can gather information and content from one or more pages of a website for a company, and can automatically find and organize disparate financial documents, such as through the application of heuristics that are related to the available content, wherein the heuristics can be specific to the type of documents that are encountered. The system and method reorganize the available content within a link database, to provide standard accessibility. In some embodiments, the available documents are available through a standardized user interface, wherein financial, regulatory, and disclosure documents are presented as hyperlinks within a linked table.

### CROSS REFERENCE TO RELATED APPLICATIONS

This Application claims priority to U.S. Provisional Application No. 62/131,176, filed on 10 Mar. 2015, which is incorporated herein in its entirety by this reference thereto.

### FIELD OF THE INVENTION

At least one embodiment of the present invention pertains to a method and system for converting disparate documents to a linked table. More particularly, at least one embodiment of the present invention pertains to a method and system for converting disparate financial, regulatory, and disclosure documents to a linked table.

### BACKGROUND

Public companies maintain investor relations websites. Corresponding investor relations websites often contain a wide variety of documents, such as investor presentations, quarterly earnings and other press releases, SEC filings, annual reports, webcasts, transcripts, and letters to shareholders. However, each investor relations website has a unique layout for the corresponding company, which becomes burdensome for a user to navigate in a consistent manner.

In addition, the various aforementioned documents that investors seek are distributed over multiple Web pages. Thus, accessing a document requires multiple clicks by the user, i.e., multiple round-trip times over the Internet. For instance, an investor typically has to navigate to the investor relations website of the company first, and then has to search through the various links to find the locations of the investor presentations, quarterly earnings and other press releases, SEC filings, and letters to shareholders. Furthermore, because the documents are distributed over multiple webpages, access to multiple documents results in extra latency. These factors lead to reduced investor productivity.

### BRIEF DESCRIPTION OF THE DRAWINGS

One or more embodiments of the present invention are illustrated by way of example and not limitation in the figures of the accompanying drawings, in which like references indicate similar elements.

FIG. 1 shows an investor relations website for a company, in which a variety of company presentations are listed.

FIG. 2 shows an investor relations website that lists annual reports for a company, and through which related resource content and source code can be accessed.

FIG. 3 shows an investor relations website that lists company presentations for a company, and through which related resource content and source code can be accessed.

FIG. 4 shows an investor relations website that lists multiple presentations for one particular financial community event for a company, and through which related resource content and source code can be accessed.

FIG. 5 is a schematic diagram of an illustrative system environment for converting disparate financial, regulatory, and disclosure documents to a linked table and database.

FIG. 6 is a table that shows illustrative 8-K filing for a company, with associated attachments.

FIG. 7 is a table that shows illustrative 8-K filing for a different company than that shown in FIG. 6, with associated attachments.

FIG. 8 is a block schematic diagram of an illustrative method and system for converting disparate financial, regulatory, and disclosure documents to a linked table.

FIG. 9 is a schematic diagram of an illustrative link feeder database.

FIG. 10 is a schematic diagram of illustrative feeder heuristics.

FIG. 11 is a schematic diagram of an illustrative links database.

FIG. 12 is a block schematic diagram showing a further illustrative embodiment of a method and system for converting disparate financial, regulatory, and disclosure documents to a linked table.

FIG. 13 is a schematic diagram of an annual report database.

FIG. 14 is a schematic diagram of an presentation database.

FIG. 15 is a screenshot of the herein disclosed website for the Walt Disney Company.

FIG. 16 is a screenshot of the herein disclosed website for Intel Corporation.

FIG. 17 is a screenshot of the herein disclosed website for the Well Fargo Corporation.

FIG. 18 shows an illustrative user interface that is configured to simultaneously display a plurality of financial documents for a selected financial entity.

FIG. 19 is a high-level block diagram showing an example of a processing device that can represent any of the systems described herein.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description.

Introduced here are enhanced methods and systems for converting disparate documents to a linked table. More particularly, introduced here are methods and systems for converting disparate financial, regulatory, and disclosure documents to a linked table.

In certain embodiments, the linked table is accessible through a common webpage that provides selectable links to the documents.

In certain embodiments, the system and method are configured to simultaneously display a plurality of documents for a financial entity through a single user interface.

As discussed above, websites for different companies have unique layouts. As such, an investor user is often required to first navigate to an investor relations website of a company of interest, and then must search through various links, i.e., between different webpages for the investor relations website, to find the locations of different documents related to the company, such as to access any of investor presentations, quarterly earnings and other press releases, SEC filings, webcasts, transcripts, and letters to shareholders. Because the documents are distributed over multiple webpages, the investor also suffers extra latency in accessing them.

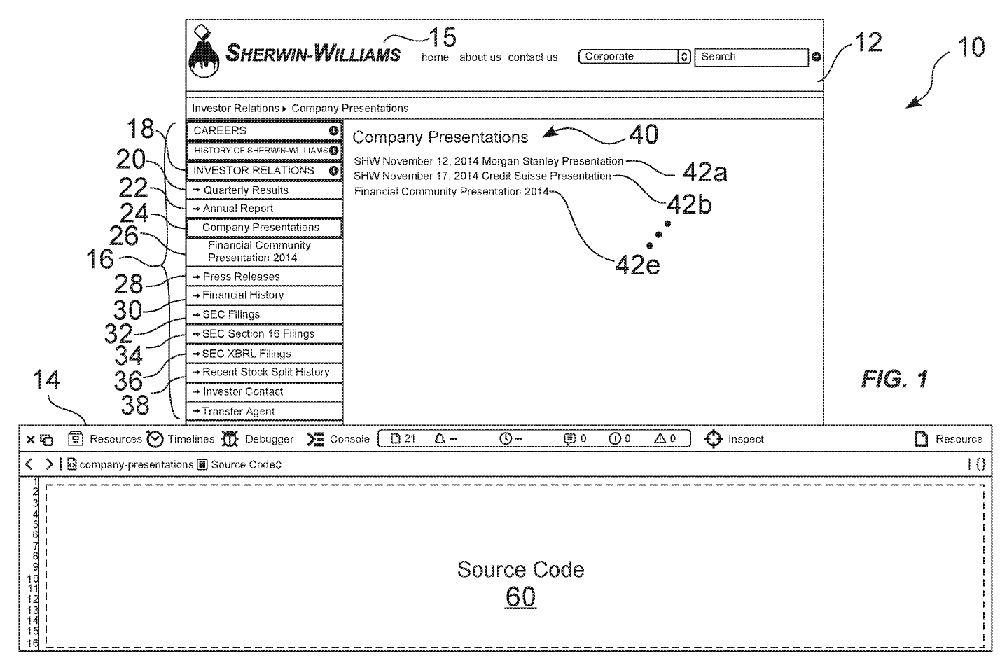

For example, FIG. 1 shows an investor relations website 10 for a company 15, e.g., Sherwin-Williams, in which the displayed webpage 12 lists a variety of company presentations 42, e.g., that are available to a user. The illustrative webpage 12 seen in FIG. 1 also includes links 16 to other information, documents, and/or presentations, such as any of an investor relations link 18, a quarterly results link 20, an annual report link 22, a company presentations link 24, a Financial Community Presentation link 26, a press releases link 28, a financial history link 30, a Securities Exchange Commission (SEC) filings link 32, an SEC Section 16 filings link 34, an SEC XBRL filings link 36, and a recent stock split history link 38. An illustrative coding interface 14 that is associated with the webpage 12 is also shown in FIG. 1, through which associated source code 60 can be accessed.

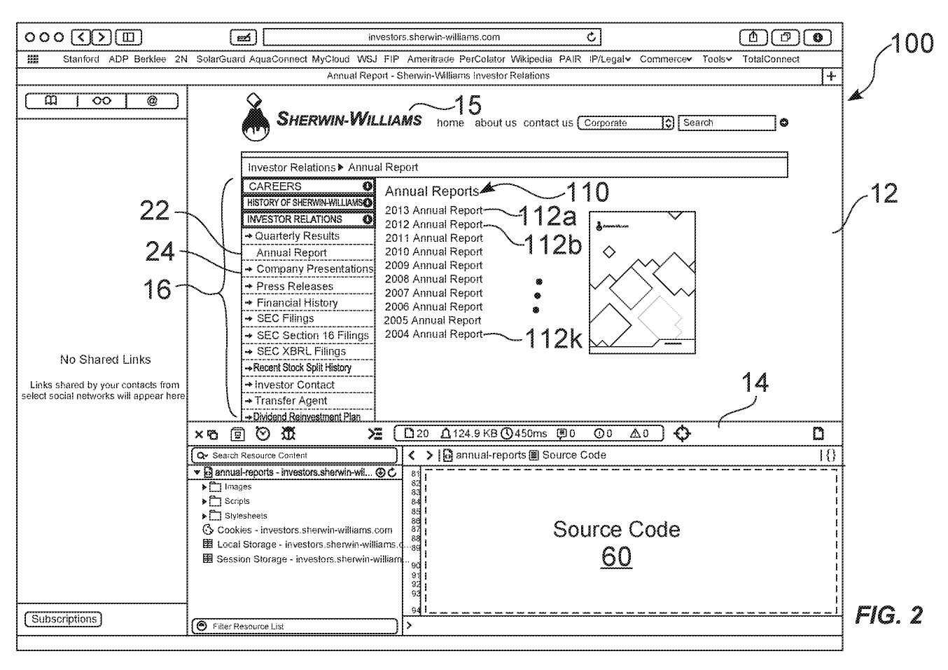

While a typical webpage 12 for an investor relations website may include links to one or more specific documents 42, the investor user is typically required to navigate through a plurality of links, e.g., links 16, to find one or more documents. For example, FIG. 2 is an illustrative view 100 of an investor relations webpage 12 that lists annual reports 110 for Sherwin-Williams 15. For instance, the annual reports 110 that are accessible though the webpage 12 seen in FIG. 2 include annual report documents 112, e.g., 112a-112k for different respective years. Access to the illustrative webpage 12 seen in FIG. 2 may require navigation from a different webpage 12, such as by user selection of the annual report link 22 seen in FIG. 1.

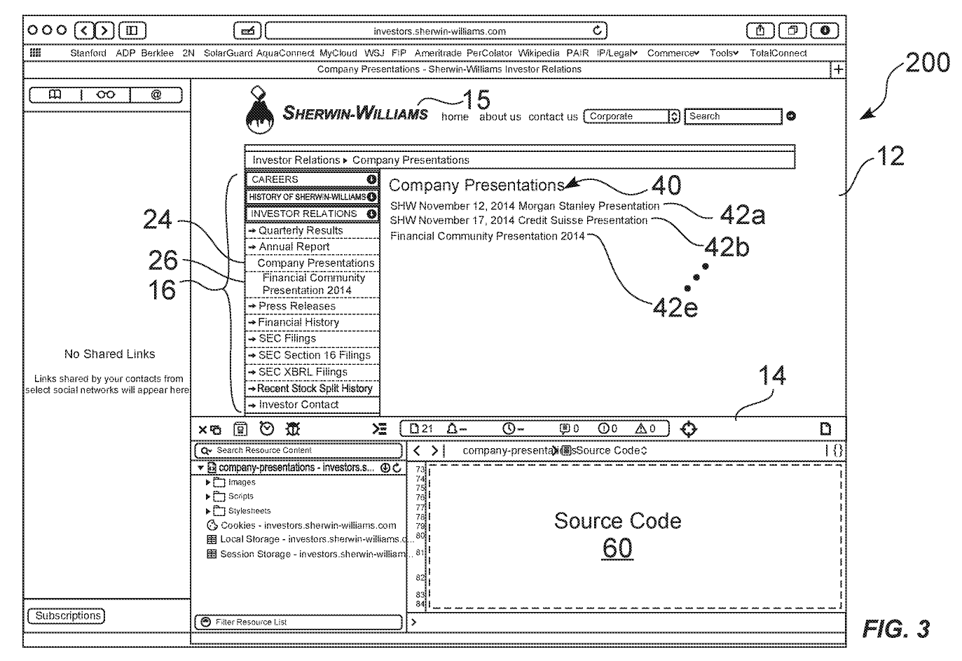

FIG. 3 is an illustrative view 200 of an investor relations website 12 that lists company presentations 40 for Sherwin-Williams 15, which may alternately be accessed by navigation from a different webpage 12, such as by user selection of the company presentations link 24 seen in FIG. 2.

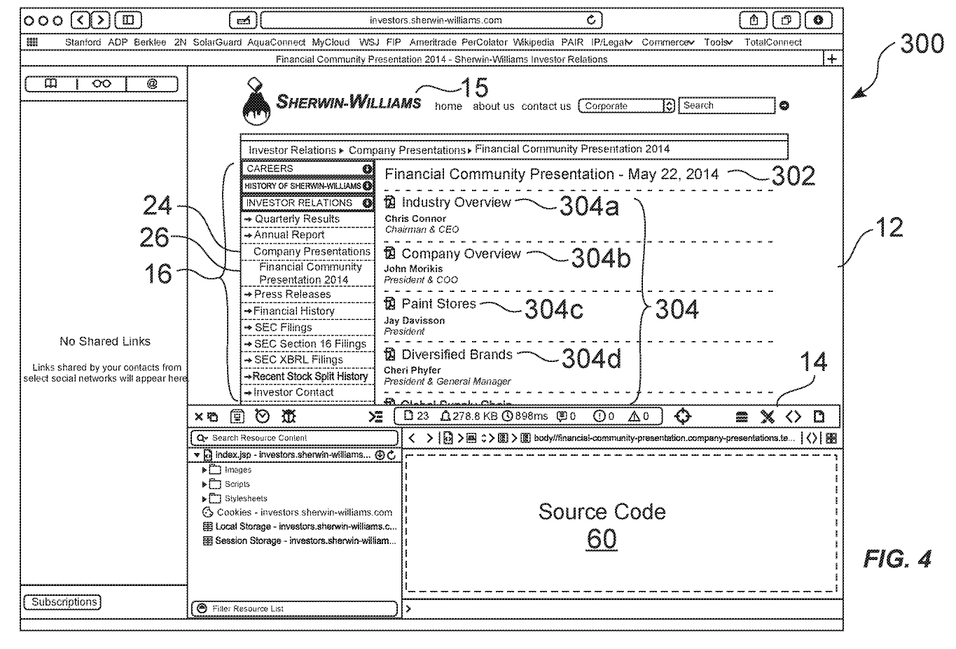

FIG. 4 is an illustrative view 300 of an investor relations website 12 that lists multiple presentations 304, e.g., 304a-304d, associated with a particular financial community event 302 for Sherwin-Williams 15 which, for example, may be accessed by navigation from a different webpage 12, such as through user selection of the Financial Community Presentations link 26 seen in FIG. 3. As seen in FIG. 4, documents 304 that are listed for an illustrative financial community presentation 302 include an industry overview document 304a, a company overview document 304b, a paint stores document 304c, and a diversified brands document 304d.

As illustrated in FIG. 1 through FIG. 4, an investor user is typically required to navigate through several unique layouts for a company 15 of interest, which becomes burdensome for the user to navigate in a consistent manner, for the specific company 15 and, in addition, for accessing such information for several companies 15, having different unique website and webpage layouts.

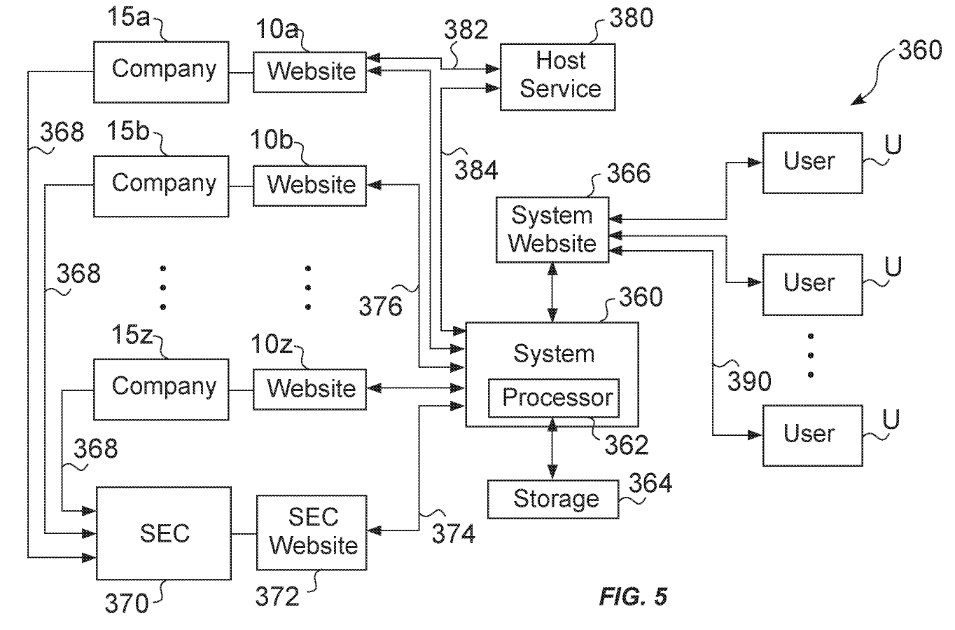

FIG. 5 is a schematic diagram of an illustrative system environment 350 for converting any of disparate financial, regulatory, disclosure, and/or presentation documents to a linked table and database. An illustrative system and process 360 seen in FIG. 5 includes a processor 362 associated therewith, which has access to a storage 364. The illustrative system and process 360 seen in FIG. 5 can be configured in relation to any number of companies 15, e.g., 15a-15z, wherein each of the companies 15 can include a corresponding investor relations website 10, e.g., 10a-10z. The illustrative system environment 350 seen in FIG. 5 also shows the Securities Exchange Commission (SEC) 370, which includes an SEC website 372. A host service 380 is also shown in the illustrative system environment 350 seen in FIG. 5. The illustrative system environment 350 seen in FIG. 5 also shows a plurality of users U that can access 390 or otherwise receive information and/or alerts from the system 360.

The illustrative companies 15, e.g., 15a-15z, seen in FIG. 5 are typically required to report 368 key documents to the SEC 370. Some embodiments of the system and process 360 can access, e.g., 374, 376, 384, information, documents, reports, and/or other content from any of the SEC website 372, directly from corporate websites 10, e.g., 10a-10z, and/or from a hosted website, e.g., 10a, such as provided by a host service 380.

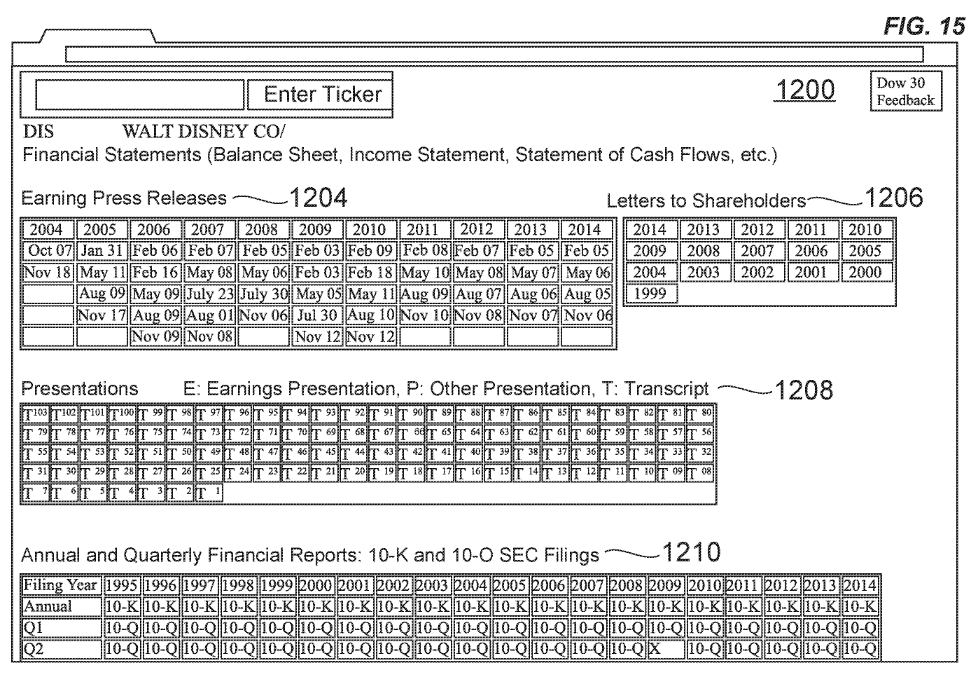

In contrast to specialized websites 10 for each financial entity 15, illustrative embodiments of the enhanced system and method 360 remove such inconsistent user interface issues. For example, illustrative embodiments of the enhanced system and method 360 can provide an enhanced website, e.g., 1202 (FIGS. 15-17), that provides a comprehensive set of links, e.g., 1204, 1206, 1208, 1210, to investor presentations, quarterly earnings and other press releases, SEC filings, and letters to shareholders, on a single screen, e.g., 1202.

The different types of investor documents are automatically gathered by the system and method 360. For example, for Earnings Releases, domestic companies 15 are currently required to file 8-K forms, such as indicated at 368, with the U.S. Securities and Exchange Commission (SEC) 370. These are called “Current Reports”. Only a small subset of these are earnings releases. Though earnings related releases are marked with the code 2.02, this is insufficient to identify the required documents accurately. The code number is not used consistently across companies 15. For example, American Express uses 2.02 and 7.01 for its earnings releases, while Johnson & Johnson uses 2.02 and 9.01.

In addition, the code 2.02 can be used in conjunction with other code numbers in a single 8-K report having multiple attachments, further obfuscating the search. Identifying the desired attachment can therefore not be done solely on the basis of the code number.

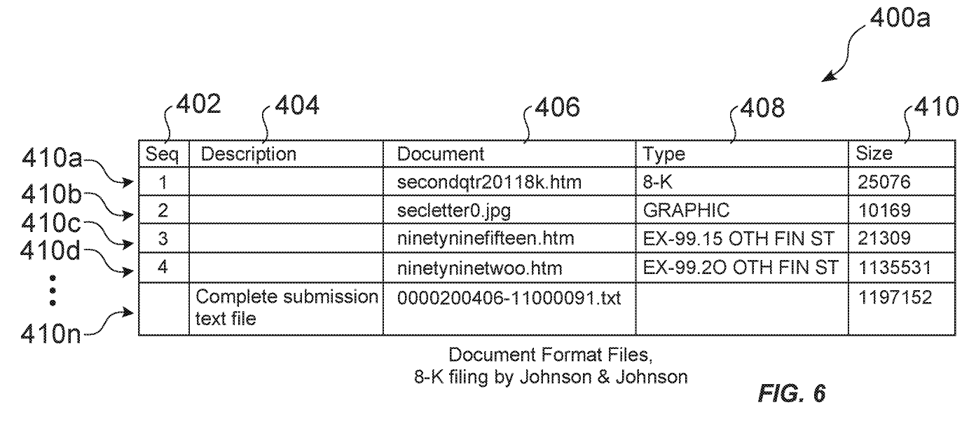

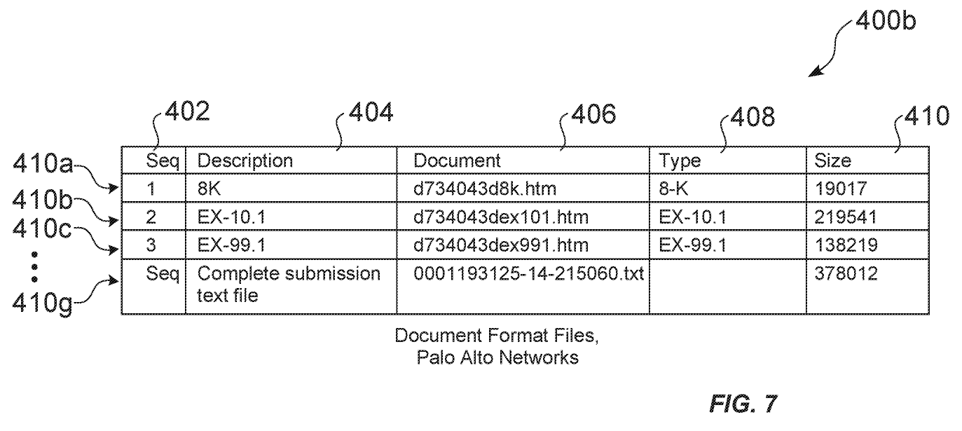

FIG. 6 is a table 400a that shows illustrative 8-K filing for a company 15, e.g., Johnson and Johnson, with associated attachments. FIG. 7 is a table 400b that shows illustrative 8-K filing for a different company 15, e.g., Palo Alto Networks, than that shown in FIG. 6, with associated attachments. As seen in FIG. 6 and FIG. 7, one or more document records 410, e.g., 410a-410n are associated with 8-K filing, and include corresponding information such as Seq 402, description 404, document ID 406, Type 408, and Size 410.

The illustrative 8-K filing 400 by Johnson & Johnson uses the codes 2.02 and 9.01. The filing 400 has four attachments 410a-410d, and it is necessary to identify which one of those four attachments designated by 410a-410d contains the earnings press release.

The illustrative 8-K filing 400b seen in FIG. 7, which corresponds to Palo Alto Networks, also contains multiple attachments. For example, one of the attachments is an agreement announcement, while another is an earnings release. The table 400b seen in FIG. 7 was obtained at the time that the related provisional application was written, at the SEC website 372.

As seen in FIG. 6 and FIG. 7, the identification of an earnings release among 8-K filings requires more sophistication.

Some embodiments of the system and process 360 solve this problem by selecting keywords that commonly appear in earnings releases, and assigning weights to them.

Some embodiments of the system and process 360 can automate the selection of such keywords, to automatically locate and identify such documents. For example, some embodiments 360 can compute a numeric score for each document in a set of documents, to pick out the an earnings release from a set of documents. In some embodiments, the score can be computed by adding up the weights of keywords that appear in the document, wherein the keywords can be enhanced with context. For example the appearance of the term “Chief Executive Officer” in a document is insufficient to enhance the score, unless the word “said” appears along with the term “Chief Executive Officer”.

Some embodiments of the system and process 360 can therefore identify such an earnings release by choosing documents with the highest scores. Documents that are identifiable by this algorithm can also include press releases that impact earnings. Examples of such press releases are layoff announcements, restructurings and reorganizations, pre-announcements of earnings shortfalls, changes in earnings guidance, etc. Accordingly, the 8-K filings chosen are not strictly quarterly earnings releases, but can be any releases that affect earnings.

Identification of Annual and Quarterly SEC Filings (10-Q and 10-K).

Identification of annual and quarterly SEC filings by the system and method 360 are more straightforward. This is because the desired document is either the first or the last in the set of attachments submitted with the SEC filing. Therefore, unlike the 8-K filings, some embodiments of the system and method 360 do not require keywords and score computations to be able to discern the information.

Some embodiments of the system and process 360 can identify the quarter for a 10-Q by the following process. Companies 15 can have their fiscal years end in any given month or day of the year. This means identifying whether a 10-Q is for the first or second or third quarter is not straightforward. Some embodiments of the system and process 360 accomplish this by first identifying the year for a 10-K, by searching for strings like “year” followed by strings like “ended” or “ending” in the 10-K. This gives the system and process 360 the fiscal year for which the 10-K is being filed. To calculate the quarter for a 10-Q, some embodiments of the system and process 360 count the number of days between the 10-Q filing date and the immediately preceding 10-K report. This count then indicates to the system and process 360 whether the 10-Q is for the first or the second or the third quarter.

Automated Gathering.

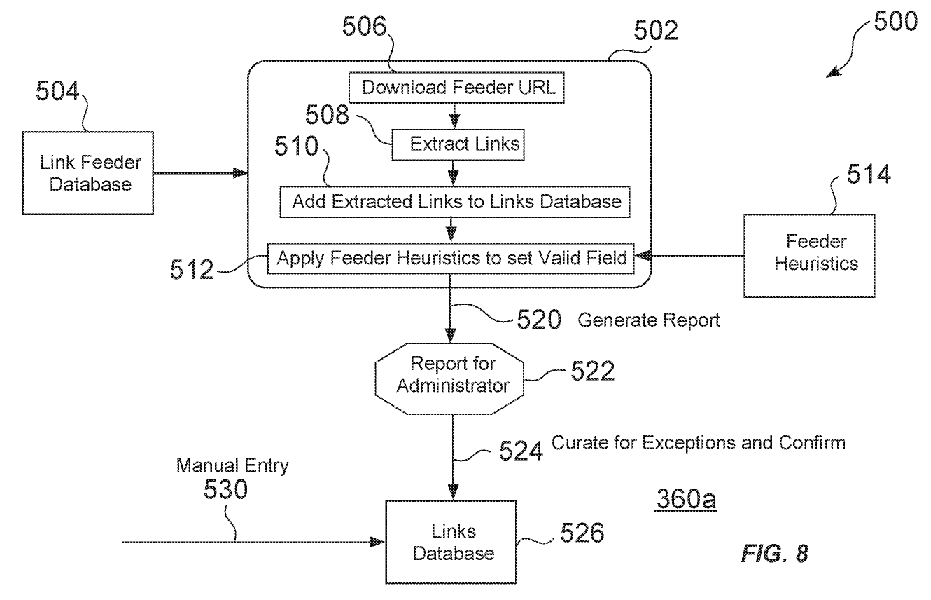

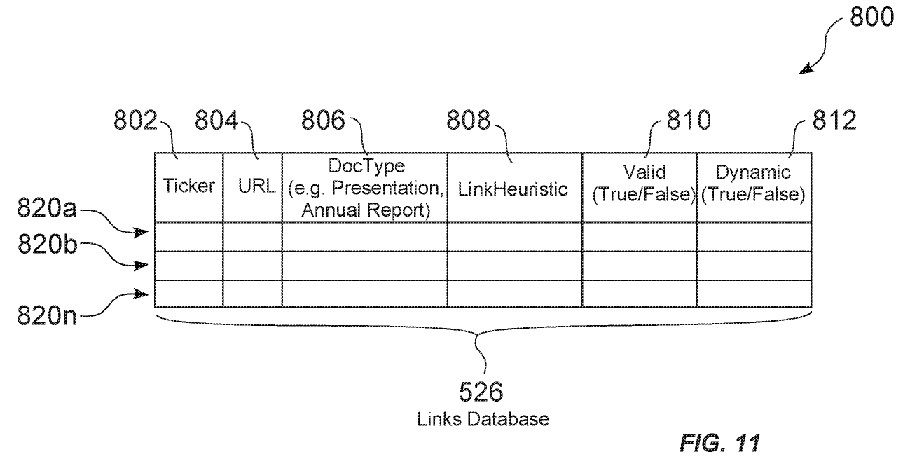

Some embodiments of the system and process 360 are configured to perform link gathering for all SEC filings such as using scripts that make use of the URL patterns used on the SEC website 372. This automation using software incorporated with the system and process 360, such as executed by the processor 362, makes handling newly added SEC filings easy; the links to the latest documents are easily fetched by the system and process 360, without requiring human intervention. These links are then added to a database, e.g., a links database 526 (FIG. 8, FIG. 11). Some embodiments of the system and process 360 can include software scripts that, when executed by the processor 362, automatically navigate the hierarchical SEC website 372, gather links to tens of thousands of documents on the SEC website 372, and arrange the gathered links in an easy-to-use user interface.

In effect, the URLs of the SEC website 372 can be navigated automatically by the system and process 360, instead of by human clicks. The SEC website 372 is exhaustive, and contains everything filed at the SEC 370 for a respective company 15. Managing this level of detail at the SEC website 372 requires a hierarchy of webpages. For example, to get a 10-Q filing by the Walt Disney Company 15, three clicks are currently needed, starting from the SEC website 372.

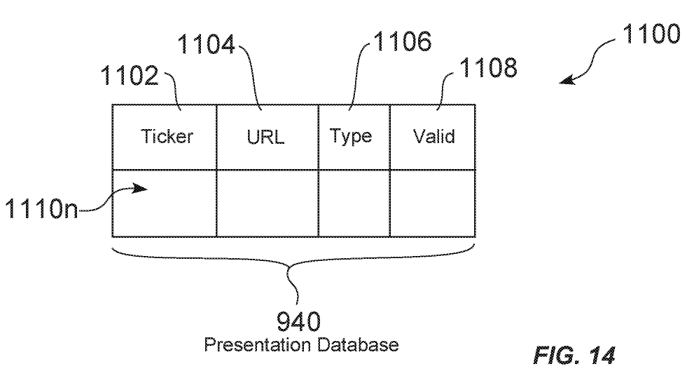

In contrast to such manual navigation, the three clicks as described above can be reduced to one-click, if the investor accesses the enhanced website 1202 (FIG. 14). For embodiments of the system and process 360 that repeat this process for as many as thousands of such documents, there is a substantial improvement in productivity.

Querying

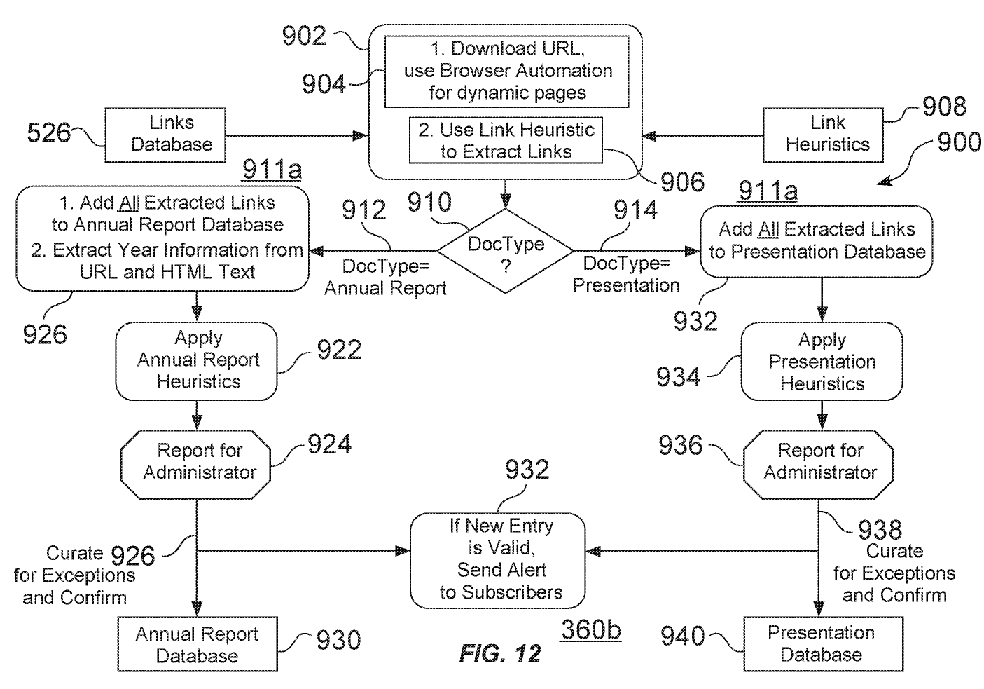

Some embodiments of the system and process 360 can store all the links to documents in a database, e.g., 526 (FIG. 8, FIG. 11), 930,940 (FIGS. 12-14). This automatic gathering and storing of links by the system and process 360 makes it possible to answer queries such as “Which 8-K filings caused significant stock price movements?”. An 8-K can be filed for any kind of corporate event; this means that collectively, companies 15 have filed many tens of thousands of 8-Ks over the years. Answering such queries about 8-K filings could not previously have been done without the automated navigation of the SEC website 372, followed by the automated gathering and storing of document information, as provided by the system and process 360.

Some embodiments of the system and process 360 can also provide a website that subscribes to a historical stock quote service, to help answer such queries. For example, companies 15 file an 8-K with the code 2.01 if they acquire or dispose of assets. They file an 8-K with the code 2.06 if they see a material impairment of assets. By linking such filings to stock prices, some embodiments of the system and process 360 can make it easy for investors to identify significant events in a company's history.

Earnings Report History

Some embodiments of the system and process 360 can collect earnings releases, wherein the system and process 360 can give users U a history of earnings reports in a single webpage. Some embodiments of the system and process 360 can, for example, take excerpts from each earnings report over the last few years, and put them on a single webpage. Users can then get an idea of the business momentum, by going over that single webpage.

Some embodiments of the system and process 360 can also allow opening all the earnings releases for a given year with a single click.

Presentations, Transcripts and Annual Reports/Letters to Shareholders.

Many documents, such as presentations, transcripts, and/or annual reports or letters, are rarely filed with the SEC 370, and instead have to be obtained from the investor relations websites of companies. Because investor relations websites have unique layouts, unlike the predictable layout of the SEC website 372, some embodiments of the system and process 360 are configured to perform an exhaustive crawl, similar to crawls done by search engines, of any given investor relations website. Such embodiments of the system and process 360 can subsequently produce a comprehensive list of documents that identify presentations, transcripts, webcasts, annual reports, and shareholder letters.

System and Process Architecture and Operation.

FIG. 8 is a block schematic diagram 500 showing an illustrative system and method 360, e.g., 360a, for converting disparate financial, regulatory, and disclosure documents to a linked table 526, which is shown in detail in FIG. 11.

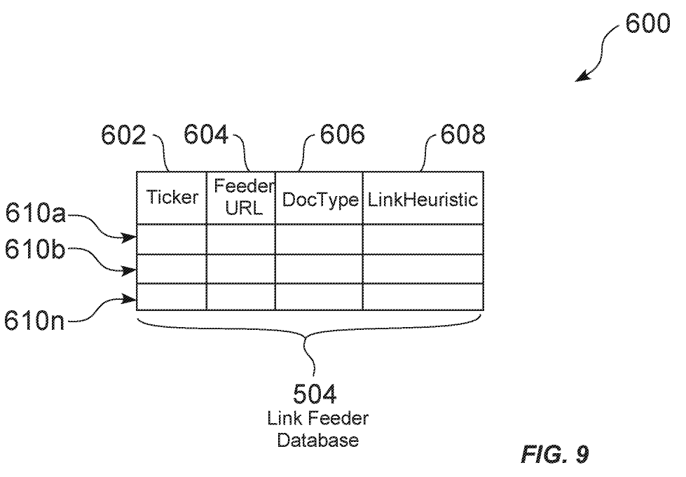

FIG. 9 is a schematic diagram 600 of an illustrative link feeder database 504, such as including a plurality of records 610, e.g., 610a-610n, wherein for each record 610, the link feeder database can include values for ticker ID 602, feeder URL 604, DocType 606, and LinkHeuristic 608.

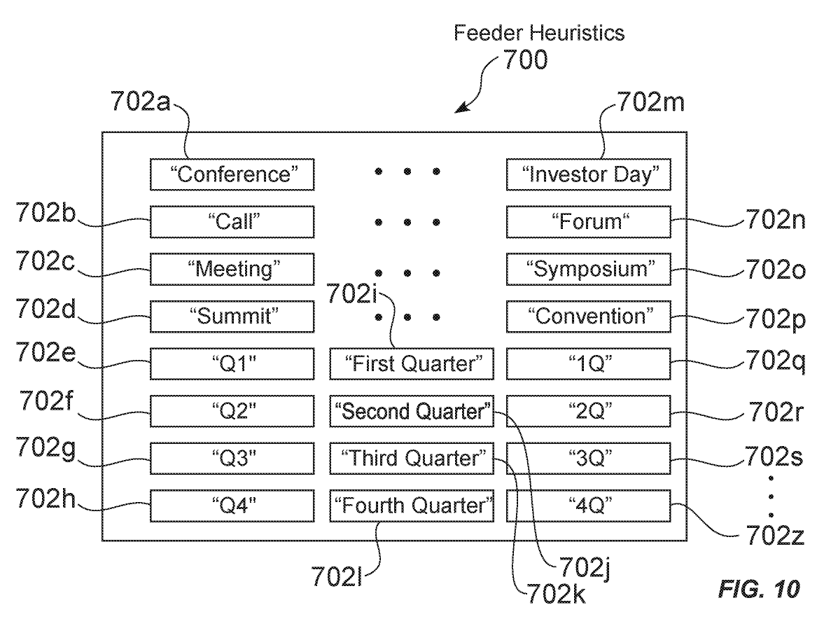

FIG. 10 is a schematic diagram 700 of illustrative feeder heuristics 702, such as including “Conference” 702a, “Call” 702b, “Meeting” 702c, “Summit” 702d, “Q1” 702e, “Q2” 702f, “Q3” 702g, “Q4” 702h, “First Quarter” 702i, “Second Quarter” 702j, “Third Quarter” 702k, “Fourth Quarter” 702l, “Investor Day” 702m, “Forum” 702n, “Symposium” 702o, “Convention” 702p, “1Q” 702q, “2Q” 702r, “3Q” 702s, and “4Q” 702z, or other related heuristics 702.

FIG. 11 is a schematic diagram of a resultant links table 800, which can be stored in an illustrative links database 526. The illustrative links table seen in FIG. 11 includes a plurality of records 820, e.g., 820a-820n, wherein for each record 820, the links database 526 can store values for any of ticker ID 802, URL 804, DocType 806, LinkHeuristic 808, Valid (True/False) 810, and Dynamic (True/False) 812. The Document type “DocType” field 806 can readily identify a wide variety of documents that can be accessed by the system and process 360, such as but not limited to presentations and periodic reports.

The process of crawling investor relations websites 10 can be made more efficient in many cases by using a database 514 of feeder heuristics 702, e.g., 702a-702z FIG. 10). The use of heuristics 702 allows the system and method 360 to identify newly added presentations/transcripts quickly, resulting in faster real-time notifications to investors. Some embodiments of the system and process 360 can look at the HTML source 60 of an investor relations website 10 to see the format of links it uses. Unlike the SEC website 372, there is no single pattern in investor relations websites. Fortunately, there are typically a finite number of patterns used on such websites 10.

For example, if ‘target=_blank’ or “target=_new” in an “a” element is seen in a link feeder database 504 associated with a website 10, the system and method 360a can guess that there is a chance that the link points to a presentation, transcript or letter to shareholders. Some illustrative embodiments of the system and process 360a can similarly guess that a link might be a presentation/transcript, such as if the URL includes “pdf”, which can indicate the presence of a file having a portable document format, or “ppt”, which can indicate the presence of a file having a PowerPoint format.

When performing any string matching in a URL, it is to be understood that the matching can be performed by the system and process 360 on both the destination address and on the text of the URL. A URL is represented in HTML source code by an “a” element as follows:

<a href=“destination address”>text</a>.

There are several host service companies 380 (FIG. 5) that host investor relations websites 10. That is, the creation and maintenance of investor relations websites 10 for companies 15 is often outsourced to these hosting companies 380. Each such investor relations website developer has a unique way of building their website and URLs. The system and method 360 can make use of patterns in the URLs they use for documents. While one such hosting service company 380 uses the substring “External” in its URL, another uses the substring “file.aspx.” Many of these URLs have the domain name of the investor relations website developer. The existence of a pattern is not mandatory, because in the worst case the system and process 360 can be configured to process every URL, download every document, and search its contents. However, the existence and identification of such a pattern can speed up the process.

As seen in FIG. 8, the system and process 360a can process 502 information from a link feeder database 504, such as using pre-determined feeder heuristics 514. For example, the system and process 360a can download 506 a feeder URL 604 (FIG. 9) from the link feeder database 504, and can extract links 508 and add 510 the extracted links to a links database 526. The process can also apply 512 the feeder heuristics 514 to set a valid field 810 (FIG. 11). In some embodiments, the output of the routine 502 can be forwarded toward the links database 526. In some embodiments, the routine 502 can generate a report 520, such as to be reported 522 to an administrator, wherein the report can be curated for exceptions and confirmed 524, before being sent to the links database 526. As also seen in FIG. 8, the system and process 360a can be configured for manual entry 530 into the links database 526.

FIG. 12 is a block schematic diagram 900 of a further method and apparatus 360, e.g., 360b, for converting disparate financial, regulatory, and disclosure documents to one or more linked tables within one or more databases, e.g., an annual report database 930 and a presentation database 940.

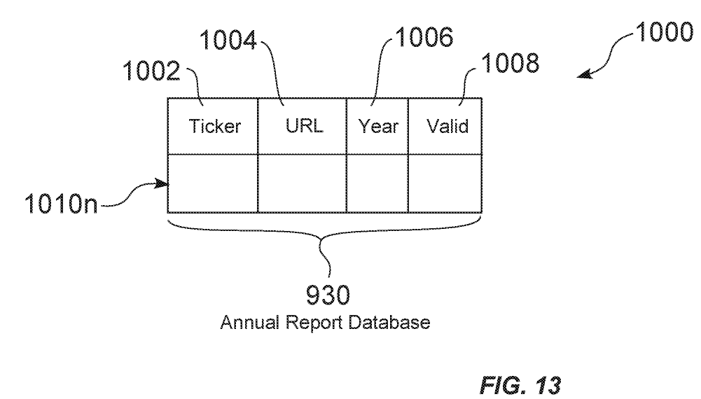

FIG. 13 is a schematic diagram of a resultant annual report table 1000, which can be stored in an illustrative annual report database 930. The illustrative annual report table 1000 seen in FIG. 13 includes record fields 1010n for corresponding values such as Ticker 1002, URL 1004, Year 1006, and Valid 1008.

FIG. 14 is a schematic diagram of a resultant presentation table 1100, which can be stored an illustrative presentation database 940. The illustrative presentation table 1100 seen in FIG. 14 includes record fields 1110n for corresponding values such as Ticker 1102, URL 1104, Year 1106, and Valid 1108.

Some websites 10 are written such that each presentation link itself is on a different webpage 12, such that accessing a presentation can require two clicks. Consequently, the system and process 360b can provide a two-level crawl for these websites 10, wherein only the second-level has been described above in relation to the system and process 360a.

Examples of such websites 10 are the investor relations websites 10 of IBM and Chevron. In such cases, it is necessary to identify the URLs to be accessed by the first click, i.e., the first-level search. Some embodiments of the system and process 360 use the names of the URLs to help speed up the first-level crawl. For example, some system embodiments can prune the search to URL names such as those in the set {“Conference”, “Q1”, “Q2”, “Q3”, “Q4”, “Quarter”, “Slides”, “Presentation”, “Meeting”, “Investor Day”, “Analyst Day”, “Symposium”, “Forum”, “Summit”, “Speaks”, “Remarks”, “Convention”, “1Q”, “2Q”, “3Q”, “4Q” } and so on.

Some websites 10 can require a hybrid of one-level and two-level crawls. For instance, the Sherwin-Williams presentation website 10 and associated webpage 202, such as displayed in FIG. 3, illustrates one such example. The first two links 42a and 42b directly point to PDF presentation files, whereas the third link 42e, entitled “Financial Community Presentation 2014,” points to another page 202 (FIG. 4) that contains the actual PDF presentation files 304a-304d.

Dynamic Websites.

Dynamic websites can also be handled by some embodiments of the system and process 360. Dynamic websites do not use static URLs right away. Instead, the URLs can be fetched from a server-side database, such as after the user selects the time period of the URLs that the user wants to see. This fetching can be done by a script in the browser. In circumstances that lack static URLs, the system and process 360 can automate the download, and save the webpage as seen by the browser, in which the saved webpage contains the URLs as seen by the browser, i.e. it contains the URLs that have been fetched from the server-side database 526.

The illustrative system and process 360b seen in FIG. 12 include a routine 902, which can input information from the links database 526 and from links heuristics 908. As noted above, the links database can include information such as ticker 802, URL 804, DocType 806, LinkHeuristic 808, Valid (True/False) 810, and Dynamic (True/False) 812. The illustrative link heuristics 908 can include heuristics such as “PDF”, HTML target=“_blank” or “_new”, and/or heuristics that are specific to corresponding IR hosting companies.

The illustrative routine 902 seen in FIG. 12 can proceed 904 to download an URL 804, and can use browser automation for dynamic pages 202. The routine 902 can then use the link heuristics 908 to extract 906 the links from the webpage 202.

The system and process 360b shown in FIG. 12 can then proceed to determine 910 a document type for each document found during routine 902, and can then proceed to process 911, e.g., 911a,911b, the information based on the type of document found.

For instance, at 912, the system and process 360b can determine 910 that a document encountered at a web site is an annual report, e.g., 112a (FIG. 2). For such a determination, the system and process 360b can proceed 912 to perform a routine 926, which adds all the corresponding extracted links to an annual report database 930, and extracts year information from the URL 804 and from the corresponding HTML text. The system and process 360b then apply annual report heuristics 922, e.g., by searching for heuristics having values such as “Annual Report”, “Editorial”, “Narrative”, Highlights”, and “Letter”, and setting the valid field 1008 in the annual report database 930. The output of the routine 922 can be forwarded toward the annual report database 930. In some embodiments, the routine 922 can be reported 924 to an administrator, wherein the report can be curated for exceptions and confirmed 924, before being input to the annual report database 930. As also seen in FIG. 12, the system and process 360, e.g., 360b, can send 932 a corresponding alert to subscribers U if the new entry 1010n is valid 1008.

FIG. 12 shows 900 a further illustrative example of processing that is specific to document type, at 914, wherein the system and process 360b can determine 910 that a document encountered at a web site is presentation, e.g., 42a (FIG. 1, FIG. 3). For such a determination, the system and process 360b can proceed 914 to perform a routine 932, which adds all the corresponding extracted links to the presentation database 940. The system and process 360b then apply presentation heuristics 934 to classify the information, e.g., by searching for heuristics having values such as including any of “Slides”, “Earnings”, “Presentation”, “Transcript”, “Chart”, “Remarks”, “Webcast”, “Q1, “Q2”, Q3”, “Q4”, “Quarter”, “1Q”, “2Q”, “3Q”, “4Q”, “cc.talkpoint”, etc. The output of the routine 934 can be forwarded toward the presentation database 940. In some embodiments, the routine 934 can be reported 936 to an administrator, wherein the report can be curated for exceptions and confirmed 938, before being input to the presentation database 940. As also seen in FIG. 11, the system and process 360b can send 932 a corresponding alert to subscribers U if the new presentation entry 1110n is valid 1108.

As noted above, FIGS. 1-4 show illustrative screen shots of an investor relations website 10 for a financial entity, e.g., the Sherwin-Williams Company 15. FIG. 1 is the main investor relations webpage. FIG. 2 shows the webpage that lists annual reports for Sherwin-Williams, FIG. 3 shows the main investor presentations webpage for Sherwin-Williams, and FIG. 4 shows the webpage that lists presentations for the Sherwin-Williams event on May 22, 2014. In FIGS. 1-4, the related source code 60 and corresponding interface 14 are also indicated, where the source code 60 shows the various URLs and attributes that make up the web pages 12. The system and process 360 can be configured to determine which URL corresponds to specific documents, such as a presentation, a transcript, an annual report, a letter to shareholders, a webcast, or other documents. To do this, some embodiments of the system and process 360 can look for specific identifying features in the URL. A set of URLs is gathered and tested to determine if the URLs lead to a presentation, a transcript, a webcast, a shareholder letter, an annual report, or other document.

Once the heuristic/pattern for a certain investor relations website 10 is identified, it is entered into the system database. The identification of investor presentations and annual report pages for a company, followed by the identification of the heuristic, can be accomplished with a one-time effort.

Some embodiments of the system and process 360 can make use of both the destination address and the text of the URL. For example, if the information contains keywords from the set {“Presentation”, “Slides”, “Charts”, “Earnings”, “Transcript”, “Script”, “Speech”, “Results”, “Remarks”, “Webcast”, “Q1”, “Q2”, “Q3”, “Q4”, “Quarter”, “1Q”, “2Q”, “3Q”, “4Q”}, the system and process 360 can conclude that the URL is likely a presentation. Some embodiments of the system and process 360 can use these same keywords to classify the presentation as any of a transcript a webcast, an earnings presentation, or any other presentation.

The year of the annual report or shareholder letter can be extracted from the URL or HTML text. Some embodiments of the system and process 360 can use the strings {“Annual Report”, “Editorial”, “Letter”, “Narrative”, “Highlights”, “Review”} to identify annual reports and shareholder letters. In some embodiments, such as seen in FIGS. 15-17, the system website 1202 arranges the shareholder letters and annual reports by the year.

Curation of Gathered Links.

As seen in FIG. 12, after the presentations/transcripts/annual reports/shareholder letters are harvested from a website, they can be reported, e.g., 924,936, such as on a webpage, to be manually curated, e.g., 926,938, for 100% accuracy. Some embodiments of the system and process 360 can apply heuristics, e.g., 922,934, that are sufficiently accurate so that the process of manual curation and confirmation is very fast and easy. Most of the time, manual intervention is not needed. The few URLs rejected as false positives after such curation continue to be stored in the database. This is so that new documents can be identified as and when they appear; links that don't appear in the database are potentially new presentations or annual reports.

Some embodiments of the system and process 360 can also potentially automate the curation process. These documents are almost always in PDF format. The documents can be first converted to text. Then, to identify presentations, transcripts and shareholder letters from this list, the system and process 360 can use a keyword and scoring technique similar to the one used for selecting earnings releases.

Currently, in the system database, companies 15 in the S&P 500, for instance, average roughly thirty presentations/transcripts and ten shareholder letters/annual reports per company 15. The use of heuristics and automation by the system and process 360 saves a substantial amount of time in processing and storing the documents corresponding to this volume of companies.

Investor alerts.

Several finance websites let users enter stocks in a portfolio. Stock prices, graphs, news and financial data for the portfolio are displayed on these websites. However, no known conventional website notifies users when new financial documents, such as presentations and annual reports, become available for any stock in the portfolio.

Websites do exist where one can get SEC filing notifications, perhaps because unlike investor relations websites, it is easier to navigate the SEC website 372 automatically. However, presentations, transcripts, and shareholder letters are the most favored documents by investors U, because they convey the most relevant information about a company in an easy-to-understand manner.

Also, no public website currently sifts the SEC 8-K filings to identify earnings releases automatically. Subscribing for alerts to all SEC 8-K filings without sifting would result in hundreds of false-positive notifications for an investor U seeking earnings information. This enormous false-positive rate is likely to discourage many investors from signing up for alerts, because most investors just want earnings information.

The advantage of automatic software-based gathering, such as executed by the system and process 360, is that it becomes very easy to identify new presentations and notify investors as soon as the new presentations become available. Individual investor relations websites offer a notification service for their particular stock; but many seem to announce only the date when a presentation is to be made by the company, instead of notifying users at the time the presentation is uploaded onto the website. Even if all companies were to offer such a service through their investor relations websites, an investor following say 100 stocks would have to sign up for or sign out of such a service on the 100 different investor relations websites. In contrast, the investor would find it far easier to manage his notifications in a single place when they are offered by the herein disclosed website.

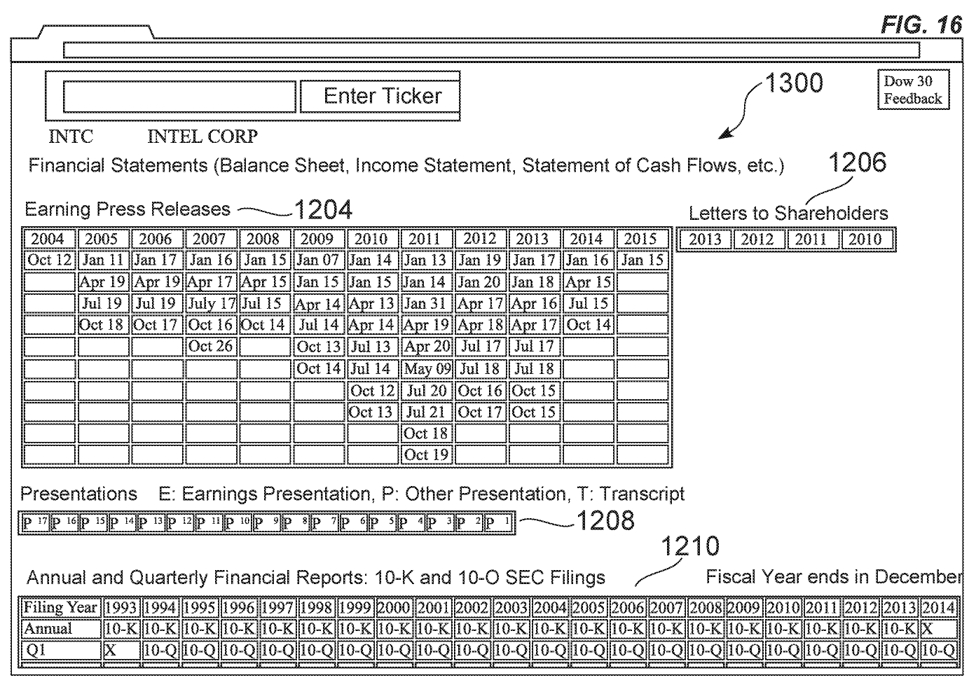

FIG. 15 is a screenshot of 1200 an enhanced website 1202 for the Walt Disney Company 15. FIG. 16 is a screenshot 1300 of an enhanced website 1202 for

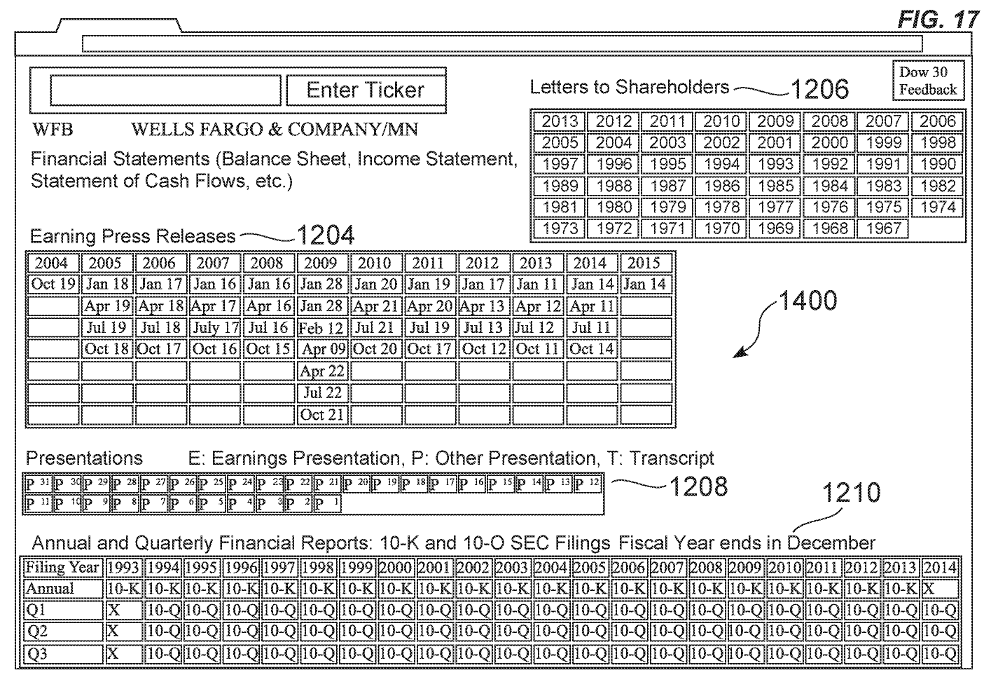

Intel Corporation 15. FIG. 17 is a screenshot 1400 of an enhanced website 1202 for the Well Fargo Corporation 15.

In some embodiments, all companies 15 can share the same layout 1202, e.g., a plain or spartan layout. Professional investors typically follow a large number, e.g., hundreds, of companies and stocks. The use of a common layout 1202 causes less strain for such an investor U, who can access the documents they want far more easily through a common user interface 1202.

As seen in FIGS. 15-17, the enhanced webpage 1202 can conveniently provide a comprehensive set of links that correspond to a company 15, such as for earning press releases 1204, letters to shareholders 1206, presentations 1208, as well as annual and quarterly financial reports 1210.

In some embodiments, the enhanced user interface 1202 can present links that are stored in grids or tables, arranged by date. For instance, a single screen 1202 can easily show a hundred or more links than can be arranged by type and date.

For example, in the illustrative webpage 1202 seen in FIG. 15, there are a total of 240 Walt Disney financial documents linked in this single screenshot. The presentations can be coded with a prefix: “T” for Transcript, “E” for Earnings, “W” for webcast, “P” for any other presentation. As well, the presentations can be numbered in chronological order.

The enhanced website layout 1202 can readily be contrasted with the corresponding investor relations websites that are currently available to investor users. For example, FIG. 15 can be contrasted to the investor relations website 10 for the Walt Disney Company, FIG. 16 can be contrasted to the investor relations website 10 for Intel Corporation, and FIG. 17 can be contrasted to the investor relations website 10 for Wells Fargo Bank LLC.

If an investor follows, for example fifty stocks, the investor would have to navigate fifty different investor relations websites frequently, all with unique, customized layouts. The herein disclosed system and process 360 can provides a website that displays the documents for all fifty stocks in a single webpage, when the user creates a portfolio with these fifty stocks. The uniform user interface for all stocks and the single-click required for access make the process of investment research less burdensome.

Financial Statements Side by Side.

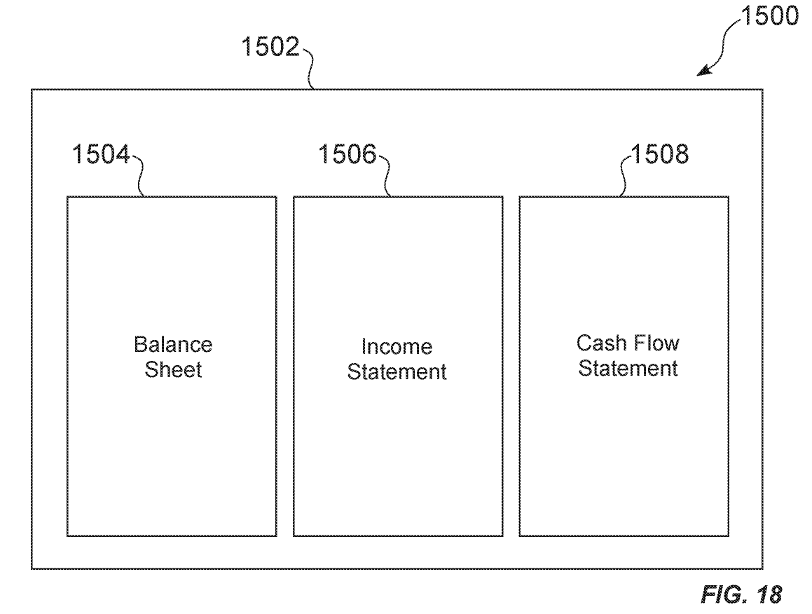

Some embodiments of the system and process 360 can show the latest balance sheet 1504, income statement 1506 and cash flow statement 1508, obtained from the SEC website 372, side by side on the same screen 1502 (FIG. 18). This makes it very convenient for investors. While the SEC website 372 can concurrently show all financial statements on the same screen, such documents are displayed one below the other, which makes viewing and analysis less convenient for the user. Even less convenient is the format used by Yahoo Finance and others, which use three different webpages for the balance sheet, income statement, and cash flow statement. The user cannot study them side by side within a single display window, and instead has to click back and forth.

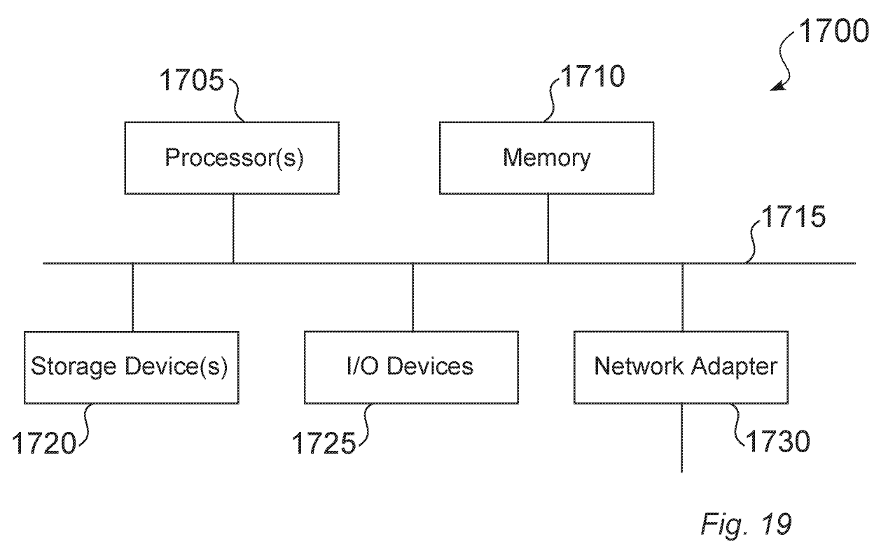

FIG. 19 is a block diagram of a computer system as may be used to implement certain features of some of the embodiments of the system and process 360. The computer system may be a server computer, a client computer, a personal computer (PC), a user device, a tablet PC, a laptop computer, personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 1700 may include one or more central processing units (“processors”) 1705, memory 1710, input/output devices 1725 (e.g., keyboard and pointing devices, touch devices, display devices), storage devices 1720 (e.g., disk drives), and network adapters 1730 (e.g., network interfaces) that are connected to an interconnect 1715. The interconnect 1715 is illustrated as an abstraction that represents any one or more separate physical buses, point to point connections, or both connected by appropriate bridges, adapters, or controllers. The interconnect 1715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The memory 1710 and storage devices 1720 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non-transitory, media) and computer-readable transmission media.

The instructions stored in memory 1710 can be implemented as software and/or firmware to program the processor(s) 1705 to carry out actions described above. In some embodiments, such software or firmware may be initially provided to the processing system 1700 by downloading it from a remote system through the computing system 1700 (e.g., via network adapter 1730).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Unless contrary to physical possibility, it is envisioned that (i) the methods/steps described above may be performed in any sequence and/or in any combination, and that (ii) the components of respective embodiments may be combined in any manner.

Those skilled in the art will appreciate that the logic and process steps illustrated in the various flow diagrams discussed below may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of sub-steps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended examples. Accordingly, the specification, drawings, and attached appendices are to be regarded in an illustrative sense rather than a restrictive sense.

1. A method for converting documents associated with a company to a linked table, comprising:
downloading one or more uniform resource locators (URLs) for a website having a plurality of disparate documents associated therewith;
extracting links to the documents from the downloaded URLs;
adding the extracted links to a links database; and
applying a set of heuristics to set field values for the links database, wherein the links database provides a linked table through which the documents are accessible by the user.

2. The method of claim 1, wherein the documents include any of financial documents, regulatory documents, and disclosure documents.

3. The method of claim 1, wherein the documents comprise any of earnings press releases, letters to shareholders, presentations, transcripts, and financial reports.

4. The method of claim 3, wherein the financial reports comprise any of annual financial reports and quarterly financial reports.

5. The method of claim 1, wherein the field values for include a ticker ID, an URL ID, a Document Type, a Link Heuristic, a Valid (True/False) value, and a Dynamic (True/False) value.

6. The method of claim 1, wherein the feeder heuristics include any of “Conference” 7, “Call”, “Meeting”, “Summit”, “Q1”, “Q2”, “Q3”, “Q4”, “First Quarter”, “Second Quarter”, “Third Quarter”, “Fourth Quarter”, “Investor Day”, “Forum”, “Symposium”, “Convention”, “1Q”, “2Q”, “3Q”, and “4Q”.

7. The method of claim 1, further comprising:
simultaneously displaying a plurality of financial statements to the user, wherein the financial statements correspond to a specific time period for a selected financial entity, wherein the related financial statements include a balance sheet, and income statement, and a cash flow.

8. The method of claim 1, further comprising:
selecting keywords that appear in the documents;
assigning weights to the keywords; and
identifying one or more of the documents based on the assigned weights.

9. The method of claim 1, further comprising:
establishing a single web page for the company, wherein the single webpage includes links for earnings press releases, letters to shareholders, presentations, annual reports, and yearly financial reports.

10. The method of claim 8, wherein the presentations includes any of an earning presentation, a transcript, or other presentation.

11. The method of claim 1, further comprising:
establishing a webpage that displays side by side a balance sheet, and income statement, and a cash flow statement for the company.

12. The method of claim 1, further comprising:
using link heuristics from the links database to extract links corresponding to a selected document;
determining a document type for the selected document;
adding the extracted links to a database associated with the determined document type;
applying a set of heuristics that correspond to the determined document type; and
entering the output within the database associated with the determined document type.

13. The method of claim 12, further comprising:
providing the output to an administrator for any of curation and confirmation before entering the output within the database associated with the determined document type.

14. The method of claim 1, wherein the website is a hosted website.

15. A system for converting documents associated with a company to a linked table, comprising:
a storage; and
a processor associated with the storage and linked over a network to a website, the processor enable to perform a method comprising:
downloading one or more uniform resource locators (URLs) for the website, wherein the website has a plurality of disparate documents associated therewith;
extracting links to the documents from the downloaded URLs;
adding the extracted links to a links database at the memory; and
applying a set of heuristics to set field values for the links database, wherein the links database provides a linked table through which the documents are accessible by the user.

16. The system of claim 15, wherein the documents include any of financial documents, regulatory documents, and disclosure documents.

17. The system of claim 15, wherein the documents comprise any of earnings press releases, letters to shareholders, presentations, transcripts, and financial reports.

18. The system of claim 17, wherein the financial reports comprise any of annual financial reports and quarterly financial reports.

19. The system of claim 15, wherein the field values for include a ticker ID, an URL ID, a Document Type, a Link Heuristic, a Valid (True/False) value, and a Dynamic (True/False) value.

20. The system of claim 15, wherein the feeder heuristics include any of “Conference” 7, “Call”, “Meeting”, “Summit”, “Q1”, “Q2”, “Q3”, “Q4”, “First Quarter”, “Second Quarter”, “Third Quarter”, “Fourth Quarter”, “Investor Day”, “Forum”, “Symposium”, “Convention”, “1Q”, “2Q”, “3Q”, and “4Q”.

21. The system of claim 15, wherein the method performed by the processor further comprises:
simultaneously displaying a plurality of financial statements to the user, wherein the financial statements correspond to a specific time period for a selected financial entity, wherein the related financial statements include a balance sheet, and income statement, and a cash flow.

22. The system of claim 15, wherein the method performed by the processor further comprises:
selecting keywords that appear in the documents;
assigning weights to the keywords; and
identifying one or more of the documents based on the assigned weights.

23. The system of claim 15, wherein the method performed by the processor further comprises:
establishing a single web page for the company, wherein the single webpage includes links for earnings press releases, letters to shareholders, presentations, annual reports, and yearly financial reports.

24. The system of claim 23, wherein the presentations includes any of an earning presentation, a transcript, or other presentation.

25. The system of claim 15, wherein the method performed by the processor further comprises:
establishing a webpage that displays side by side a balance sheet, and income statement, and a cash flow statement for the company.

26. The system of claim 15, wherein the method performed by the processor further comprises:
using link heuristics from the links database to extract links corresponding to a selected document;
determining a document type for the selected document;
adding the extracted links to a database associated with the determined document type;
applying a set of heuristics that correspond to the determined document type; and
entering the output within the database associated with the determined document type.

27. The system of claim 26, wherein the method performed by the processor further comprises:
providing the output to an administrator for any of curation and confirmation before entering the output within the database associated with the determined document type.

28. The system of claim 15, wherein the website is a hosted website.
